(19) United States
(12) Patent Application Publication
(10) Pub. No.: US 2004/0251444 A1
(43) Pub. Date: Dec. 16, 2004

(54) Valve

(76) Inventors: Kenneth R. Levey, West Chicago, IL (US); James S. Zielinski, Schaumburg, IL (US)

Correspondence Address: PAUL F. DONOVAN, ILLINOIS TOOL WORKS INC., 3600 WEST LAKE AVENUE, GLENVEIW, IL, 60025, US

(21) Appl. No.: 10/837,725

(22) Filed: May 3, 2004

Related U.S. Application Data
(60) Provisional application No. 60/477,441, filed on Jun. 10, 2003.
(60) Provisional application No. 60/507,280, filed on Sep. 30, 2003.

(51) Int. Cl. F16K 31/44

(52) U.S. Cl. 251/231

(57) ABSTRACT

A valve has a valve stem including a head operable in an outlet for opening and closing the valve. A resilient bulb functions as a spring for operation of the valve. A lever is used to depress the bulb and move the valve stem. The shape of the channel defined for flow through the valve consolidates the fluid stream leaving the valve.

### CROSS-REFERENCE TO RELATED APPLICATIONS

The present application claims the benefits of U.S. Provisional Application No. 60/477,441 filed on Jun. 10, 2003 and of U.S. Provisional Application No. 60/507,280 filed on Sep. 30, 2003.

### FIELD OF THE INVENTION

The present invention relates to container valves or taps, such as those used on refillable containers, including insulated beverage coolers.

### BACKGROUND OF THE INVENTION

Numerous types of valves and taps have been developed and used to dispense a wide range of fluids from various containers. One known application is for taps on consumer refillable containers, such as insulated coolers commonly used to carry several gallons of water or other beverages for large gatherings, such as sporting events, picnics and the like.

A known design for a beverage container tap or valve includes a valve body defining a channel in flow communication with the container interior. The channel forms a substantially right angle turn, having a substantially horizontal portion from the container and a substantially vertical portion leading to a downwardly directed outlet. A valve stem is disposed in the vertical portion of the channel. It is known to use a cup shaped seal of elastomeric material in the outlet on the end of the valve stem. Pushing the valve stem moves the seal downwardly, opening the outlet so that fluid can flow over the inner surface of the seal and cascade off the periphery of the seal. It is known also to use a hemispherical elastomeric bulb on the opposite end of the valve stem, at or above the valve body. The edge of the bulb is anchored against the valve body.

Pressure is applied on the bulb from a thumb or finger of the user. Depressing the bulb moves the valve stem to open the valve. The bulb acts as a spring to return the valve stem and seal to closed positions when external force on the bulb is released.

One problem associated with such tap or valve assemblies is the ease with which they can be used to dispense fluid from the container. Known designs require the use of several fingers of one or both hands to apply adequate force on the bulb to operate the valve effectively. This can place fingers of the user in an awkward position, depending on the height and position of the container. Such designs are easiest to operate at about waist height or lower. Form chest height and higher, the valve may be difficult to operate. Above head height, such as on a cabinet shelf, the valve can be extremely difficult to operate.

Since the valves are necessarily relatively small, portions of the user's hands can be in the path of fluid flowing from the valve. Even if away from the outlet stream, a user's hands can block a clear view of the outlet, leading to spills. Flow from the valve, cascading over the edge of the seal, is disorganized. Targeting the flow into a narrow container can be difficult, with spilling or splashing resulting. The manner in which the seal reseats can cause a film of the fluid to remain on the outer seal surface or edge of the seal. After the receptacle has been removed, the film may gather into a drop or drops and drip onto a surface below the valve. Further, bulb-operated valves have not had structure for holding the valve open, instead requiring constant pressure from the user against the bulb. Filling large receptacles can be tiring. As the container empties and head pressure declines, flow from known valves can be at unacceptablly reduced flow rates. The vertically oriented outlet, the cylindrical discharge around the circular seal and the overall small valve structure, form an outlet stream that is close to the container, making it difficult to position some receptacles below the valve.

What is needed is a valve or tap assembly that can be operated easily at various positions and heights, and that closes automatically to seal the outlet effectively and reduce the occurrences of drips.

### SUMMARY OF THE INVENTION

The present invention provides a valve having an elastomeric component operated by a simple lever requiring only single action for opening and automatic return to a closed position upon release of the lever. Valve body and valve stem structures shape and control fluid flow advantageously.

In one aspect thereof, the present invention provides a valve with a body defining a channel having a first channel portion in fluid flow communication with a container connected to the valve, and a second channel portion forming an outlet from the valve. A valve seat is provided within the second channel portion. A valve stem structure extends into the second channel portion, and has a head adapted to engage the valve seat to close the outlet. The valve stem structure includes a valve stem having a distal end opposite the head. The valve stem structure at least partly defines a transition for fluid flow from the first channel portion to the second channel portion. A resilient bulb is anchored to the body and connected to the distal end of the valve stem. A lever pivotally connected to the body is adapted to push against the bulb for moving the valve stem structure and opening the valve.

In another aspect thereof, the present invention provides a valve with a hollow body defining a first channel portion and a second channel portion at an angle to the first channel portion. The second channel portion defines a valve outlet having a valve seat therein. The second channel portion is accessible through an opening in the body. A valve stem structure extends from the opening through the second channel portion and has a head with a seal for engagement with the valve seat. The valve stem structure is positioned substantially along a side of the second channel portion and directs fluid flow toward the outlet. A resilient bulb is anchored to the body at the opening and is connected to the valve stem structure. A lever is pivotally connected to the body and is adapted to push against the bulb for moving the valve stem structure and opening the valve.

In still another aspect thereof, the present invention provides a fluid dispensing valve for a beverage container. The valve has a body defining a channel having a first channel portion in fluid flow communication with the container, and a second channel portion forming an outlet from the valve. The first channel portion is generally horizontal and the second channel portion is generally vertical. A valve seat is provided within the second channel portion at the outlet, and an opening through the body leads into the second channel portion. A valve stem structure extends from the opening into the second channel portion, substantially along an outward side of the second channel portion. A head engages the valve seat to close the outlet. The valve stem structure includes a valve stem having a distal end opposite the head and disposed at the opening. The valve stem structure at least partly defines a transition surface inwardly from the head for directing fluid flow from the first channel portion to the second channel portion. A resilient bulb is anchored to the body at the opening and is connected to the distal end of the valve stem. A lever pivotally connected to the body is adapted to push against the bulb for moving the valve stem structure and opening the valve.

An advantage of the present invention is providing a fluid-dispensing valve that can be operated easily and comfortably, and that closes automatically when not operated for opening.

Another advantage of the present invention is providing a fluid-dispensing valve that can be assembled easily and efficiently.

Still another advantage of the present invention is providing a fluid-dispensing valve that shapes the flow stream from the valve to provide an organized and concentrated stream at the outlet.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a perspective view of a valve in accordance with the present invention, with the valve shown in a closed position;

FIG. 2 is a cross-sectional view of the valve shown in FIG. 1, taken along line 2-2 of FIG. 1, and illustrating the valve in an opened condition for dispensing fluids therethrough;

FIG. 3 is a cross-sectional view of the valve shown in FIG. 1, taken along line 3-3 of FIG. 1;

FIG. 4 is a perspective view of the valve stem structure in the valve shown in the preceding drawings; and

FIG. 5 is a perspective view of the valve in a second orientation for use.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including” and “comprising” and variations thereof is meant to encompass the items listed thereafter and equivalents thereof, as well as additional items and equivalents thereof.

### DETAILED DESCRIPTION OF THE PREFERRED EMBODIMENT

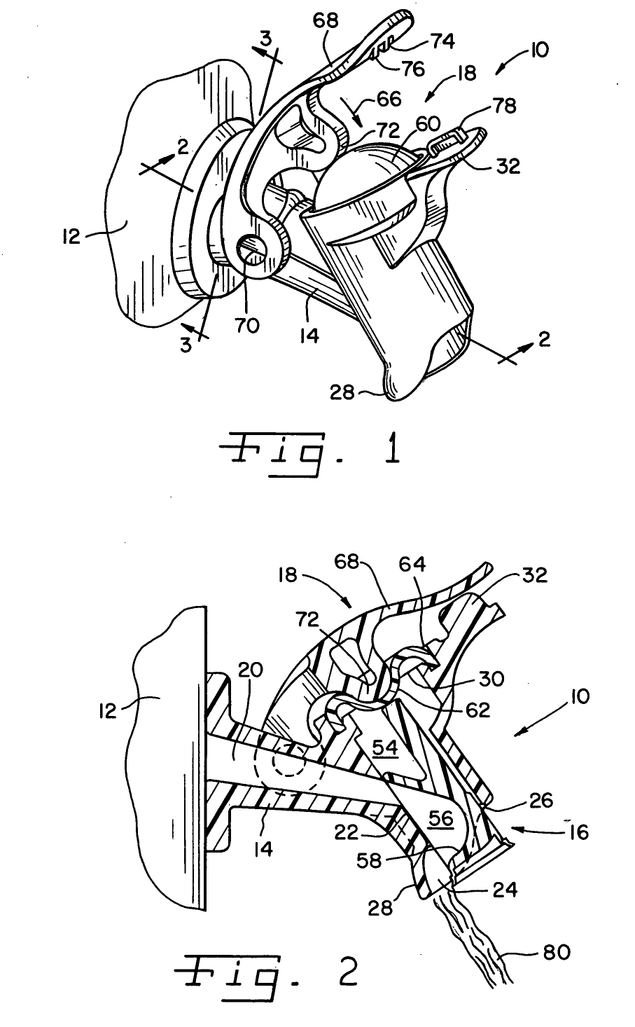

Referring now more specifically to the drawings, FIG. 1 is a perspective view of a valve assembly 10 configured in accordance with a preferred embodiment of the present invention. Valve assembly 10 can be used for dispensing liquids from a variety of packages or containers, including but not limited to refillable, large volume beverage containers, or so-called bag-in-a-box type packages. Valve assembly 10 is shown operatively associated with a container 12, such as an insulated cooler. However, those skilled in the art will appreciated and understand that other uses for the invention also are possible. For example, in one embodiment one end of the valve assembly may be provided with a male or female-thread connection system to allow it to be engaged with other components of a fluid delivery or dispensing apparatus.

Valve assembly 10 includes a main body 14, a valve stem structure 16 (FIG. 2) and an actuator mechanism 18. Body 14 is substantially hollow and defines a somewhat horizontal first channel portion 20 in flow communication with the interior of container 12. Main body 14 further defines a somewhat vertical second channel portion 22 communicating with first channel 20 and terminating at a fluid outlet 24. In the embodiment shown in FIG. 3, first channel portion 20 is oval in cross-section, to provide improved flow at low fluid volumes in container 12.

At an outer area near fluid outlet 24, body 14 defines a valve seat 26. To provide improved outlet stream shaping, in the embodiment of the invention shown, a portion of body 14 defining outlet 24 includes an outwardly extending lip 28 beyond seat 26. However, valves of the present invention can be provided without lip 28. Somewhat opposite to fluid outlet 24, valve body 14 defines an opening 30 for receiving valve stem structure 16 therein, as well as for receiving and operatively connecting with actuator mechanism 18. Adjacent opening 28, valve body 14 defines an ergonomically configured projection 32 to be used as a rest for a thumb or finger of a user when operating the valve assembly, as will be described hereinafter.

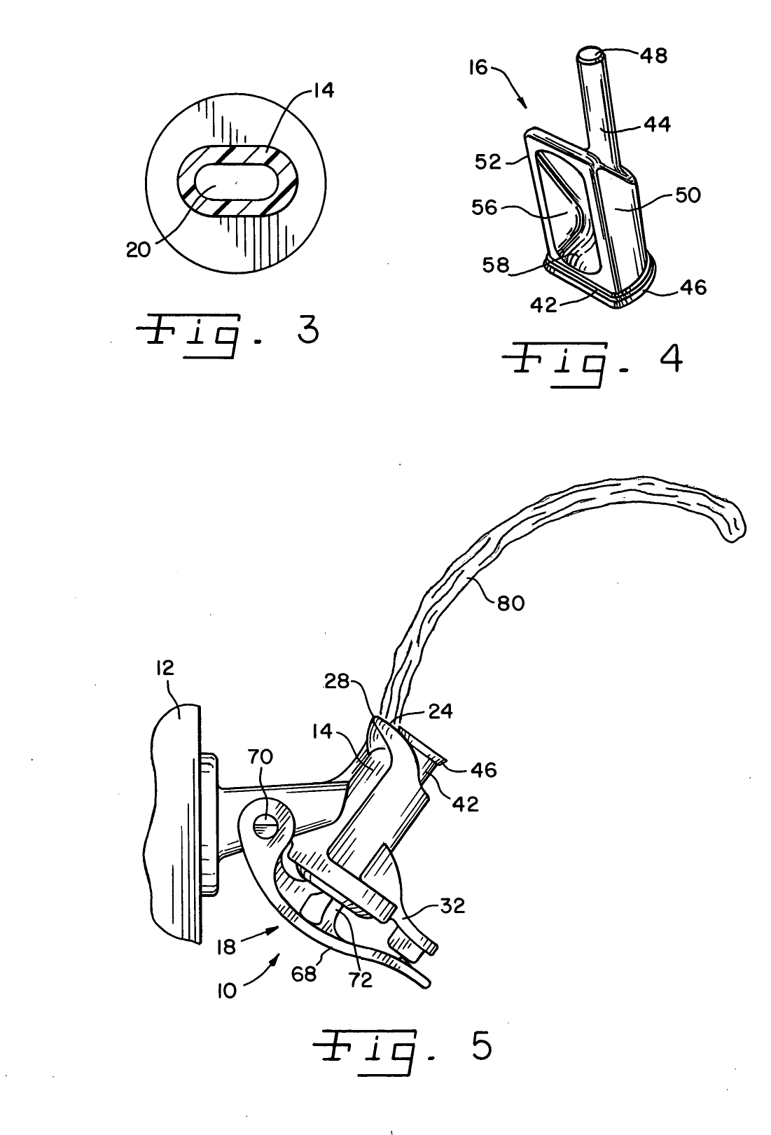

As shown in the exemplary embodiment of FIG. 4, valve stem structure 16 includes a valve head 42 and a valve stem 44, which may be formed as a single, monolithic structure as shown, or of separate parts attached together. Valve head 42 is provided to open and close fluid outlet 24, and includes a seal 46 that can engage against valve seat 26 to provide fluid tight closure of outlet 24. Valve stem 44 has a distal end 48 opposite head 42, with distal end 48 extending into opening 30. Outlet flow from valve assembly 10 is controlled by the relative position of head 42 with respect to the opposed surface of second channel portion 22, and the space, if any defined therebetween.

Valve stem structure 16 further includes a semicylindrical cup 50 having an edge 52 that slides against an inner surface 54 of body 14 defining opening 30. Cup 50, stem 44 and head 42 define a smoothly curved, fluid-directing region 56 of valve assembly 10 to redirect flow of fluid from first channel portion 20 toward outlet 24. Thus, stem structure 16 is curved in both generally axial and circumferential directions along and from cup 50 to an inner surface 58 of head 42. Surface 58 is also curved to provide smooth, less turbulent fluid flow.

Actuator mechanism 18 in the exemplary embodiment of the drawings includes a hemispherical bulb 60 of elastomeric material, such as synthetic rubber. An inner surface 62 of bulb 60 is connected to distal end 48 of valve stem 44, such as by adhesive, welding or other connecting mechanism. For example, surface 62 can be formed with a pocket (not shown) for compressively receiving distal end 48. Bulb 60 is anchored to body 14, and may be secured by press fitting the edge of bulb 60 in a circular groove 64 formed in body 14, and/or by adhesive or other means. The relative positions of the groove and edge can be reversed, with bulb 60 having an edge defining a groove for receiving a circular edge at opening 30 of body 14. Engaged with body 14 about its periphery, bulb 60 secured to body 14 functions as a seal for opening 30.

Bulb 60 is a resilient material in a shape-memory form, such that bulb 60 can be depressed as shown in FIG. 2 upon the application of external force thereto indicated by arrow 66. Bulb 60 springs back to the shape shown in FIG. 1 when external force thereagainst is removed. Depression and extension of bulb 60 causes a corresponding movement of valve stem structure 16 connected thereto. Thus, in addition to its function as a seal for opening 30, bulb 60 functions as a spring means for operation of valve stem structure 16.

Actuator mechanism 18 as shown includes a lever 68 pivotally connected to body 14 at an axis 70. An arm 72 from lever 70 is positioned substantially opposed to distal end 48, but on the opposite side of bulb 60 from distal end 48. Lever 68 can be formed as a separate element snapped onto body 14. Alternatively, those skilled in the art will understand that lever 68 can be formed as an integral part of body 14, joined to the main part of body 14 by a region of thin material forming a hinge. Lever 68 also can be shaped ergonomically together with projection 32 for ready operation by a finger or thumb of the user on lever 68 in a pinching operation with a finger or thumb on projection 32.

If valve assembly 10 is to be used for dispensing large volumes at one time, it can be advantageous to provide structure by which stem structure 16 can be held in an open position, to relieve the user from the need to apply continuous force against lever 68. Cooperating locking structures can be provided on the confronting surfaces of projection 32 and lever 68 for holding lever 68 in an open position. An example of one such structure is shown, and includes spaced locking elements 74 and 76 on one of projection 32 and lever 68, and a tab 78 on the other one thereof that is pinched between elements 74 and 76.

If intended for dispensing beverages or other fluids for consumption, valve assembly 10 is constructed of food-safe plastic or other food-safe materials. Such materials are well known to those skilled in the art.

In the use of valve assembly 10, fluid is dispensed from container 12 by grasping projection 32 and lever 68 between a thumb and finger of one hand and squeezing. Bulb 60 is depressed by arm 82, causing axial movement of valve stem structure 16. Seal 48 is moved away from valve seat 26, opening fluid outlet 24. The oval shape of first channel portion 20 and the smoothly contoured surfaces of fluid directing region 56 enhance fluid flow through valve assembly 10, even when head pressure is low as container 12 empties. Outlet 24 and lip 28 direct fluid angular away from container 12 such that a stream 80 of fluid flows at an angle of about 35 degrees from vertical, making it easier to position receptacles to receive stream 80. The configurations and positions of surfaces leading to outlet 24 shape and consolidate stream 80 for more precise filling of a receptacle.

When pinching pressure against projection 32 and lever 68 is released, bulb 60 springs back to a non-deflected shape, withdrawing head 32 into outlet 24, and seating seal 46 against valve seat 26. The generally round, peripheral disposition of seal 46 on head 42 causes a wiping action of the seal and seat surfaces, reducing potential for drips after closing.

To secure valve assembly 10 in an opened condition, sufficient pinching pressure is applied to engage tab 78 within the space defined between locking elements 74 and 76. To release lever 68, an oppositely directed force is applied, separating lever 68 and projection 32 until tab 78 is disengaged from locking elements 74 and 76. Thereafter, the springing nature of bulb 60 completes closure of valve assembly 10.

The ergonomic design and positioning of projection 32 and lever 68 away from outlet 24 makes operation easy by a simple pinching motion that can be performed comfortably for various positions of valve assembly 10 relative to the user. The user's operating hand is easily positioned to the side of valve assembly 10, thereby exposing outlet 24 and stream 80 for substantially unobstructed viewing.

Valve stem structure 16 is positioned and moves along one side of second channel portion 22, confining fluid from container 12 to flow along only one side of valve stem structure 16. Only a part of the periphery of second channel portion 22 is exposed to fluid flow, and the rate of flow from valve assembly 10 is controlled by controlling the separation between head 42 and second channel portion 22 along that part. Thus outlet 24 is confined, but unobstructed, and the fluid stream therefrom is consolidated.

The organized nature of stream 80 flowing from valve assembly 10 facilitates a use not possible with known valves. As illustrated in FIG. 5, valve assembly 10 can be inverted from the position shown in FIG. 1, such that outlet 24 is directed upwardly. Even at low head pressures from low fluid levels in container 12, stream 80 remains organized and consolidated, and projects as an arched stream upwardly and outwardly from valve assembly 10. Container 12 with inverted valve assembly 10 can be used as a drinking fountain for water, for example, allowing individuals to drink therefrom conveniently and easily without the need for glasses or other containers.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A valve comprising:
a body defining a channel having a first channel portion in fluid flow communication with a container connected to said valve, and a second channel portion forming an outlet from said valve;
a valve seat within said second channel portion;
a valve stem structure extending into said second channel portion and having a head adapted to engage said valve seat to close said outlet, said valve stem structure including a valve stem having a distal end opposite said head, said valve stem structure at least partly defining a transition surface for directing fluid flow from said first channel portion to said second channel portion;
a resilient bulb anchored to said body and connected to said distal end of said valve stem; and
a lever pivotally connected to said body and adapted to push against said bulb for moving said valve stem structure and opening said valve.

2. The valve of claim 1, said lever being snap fit on said body at a pivotal axis of said lever.

3. The valve of claim 1, said bulb having a circular edge received in a circular groove in said body.

4. The valve of claim 3, said bulb being press-fit in said groove.

5. The valve of claim 1, said valve stem structure including a curved, semicylindrical cup directing fluid flow through said first channel portion against a curved inner surface of said head.

6. The valve of claim 5, said valve stem, said head and said semicylindrical cup being a monolithic structure.

7. The valve of claim 6, said seal being a peripheral flange on said head.

8. The valve of claim 6, said body defining an outwardly projecting lip at said outlet.

9. The valve of claim 6, said first channel portion being of oval cross-section.

10. The valve of claim 9, said seal being a peripheral flange on said head.

11. The valve of claim 9, said body defining an outwardly projecting lip at said outlet.

12. The valve of claim 11, said seal being a peripheral flange on said head.

13. The valve of claim 1, said valve stem structure being monolithic.

14. The valve of claim 1, said body defining a projection in spaced, substantially confronting relationship to said lever for anchoring pinching force applied against said lever.

15. The valve of claim 14, said projection and said lever having interrelating mutually engaging structure for securing said lever near said projection.

16. A valve comprising:
a hollow body defining a first channel portion and a second channel portion at an angle to said first channel portion;
said second channel portion defining a valve outlet having a valve seat therein, and said second channel portion being accessible through an opening in said body;
a valve stem structure extending from said opening through said second channel portion and having a head with a seal for engagement with said valve seat, said valve stem structure substantially positioned along a side of said second channel portion and directing fluid flow toward said outlet;
a resilient bulb anchored to said body at said opening and connected to said valve stem structure; and
a lever pivotally connected to said body and adapted to push against said bulb for moving said valve stem structure and opening said valve.

17. The valve of claim 16, said valve stem structure including a cup shaped surface directing fluid flow toward an inner surface of said head.

18. The valve of claim 16, said body defining a lip at said outlet outwardly from said valve seat.

19. The valve of claim 16, said first channel portion being oval in cross-section.

20. A fluid dispensing valve for a beverage container, said valve comprising:
a body defining a channel having a first channel portion in fluid flow communication with the container connected to said valve, and a second channel portion forming an outlet from said valve, said first channel portion being generally horizontal and said second channel portion being generally vertical;
a valve seat within said second channel portion at said outlet;
an opening through said body leading into said second channel portion;
a valve stem structure extending from said opening into said second channel portion substantially along an outward side of said second channel portion, and having a head adapted to engage said valve seat to close said outlet, said valve stem structure including a valve stem having a distal end opposite said head, said distal end disposed at said opening, said valve stem structure at least partly defining a transition surface inwardly from said head for directing fluid flow from said first channel portion to said second channel portion;
a resilient bulb anchored to said body at said opening and connected to said distal end of said valve stem; and
a lever pivotally connected to said body and adapted to push against said bulb for moving said valve stem structure and opening said valve.
